(19) United States
(12) Patent Application Publication
(10) Pub. No.: US 2013/0191205 A1
(43) Pub. Date: Jul. 25, 2013

(54) System and method for electronic retrieval and redemption of coupons

(71) Applicants: Elijah Harkless, II, Florence, SC (US); Alvin Eugene Lawrence, Dorchester, SC (US); Jonathan W. Walker, Florence, SC (US); Chauncey E. Hunter, Florence, SC (US)

(72) Inventors: Elijah Harkless, II, Florence, SC (US); Alvin Eugene Lawrence, Dorchester, SC (US); Jonathan W. Walker, Florence, SC (US); Chauncey E. Hunter, Florence, SC (US)

(21) Appl. No.: 13/694,988

(22) Filed: Jan. 24, 2013

Related U.S. Application Data
(60) Provisional application No. 61/632,522, filed on Jan. 25, 2012.

(51) Int. Cl. G06Q 30/02

(52) U.S. Cl. CPC G06Q 30/0239
USPC 705/14.39

(57) ABSTRACT

A system and method for retrieving and redeeming product coupons, including the following steps: a) Offering a Web-based coupon retrieval and redemption application for downloading onto a compatible registered mobile device, preferably a mobile phone; b) Once the Web-based application has been downloaded and activated, receiving a coupon prompt from the mobile phone device for at least one item of interest at the store; c) Searching a system database of the Web-based application for at least one coupon corresponding to the item; d) Retrieving and forwarding the coupon to the mobile phone device in response to the coupon prompt at the store; e) Displaying the coupon in a display window of the mobile phone device; and f) Upon selection of the coupon, initiating a system for redeeming the coupon at the store.

### CROSS REFERENCE TO RELATED DOCUMENT

Benefit is claimed under 35 USC 119(e) of the filing date of provisional U.S. patent application No. 61/632,522, filed on Jan. 25, 2012 and entitled “System and Method for Electronic Retrieval and Redemption of Coupons”.

### BACKGROUND OF THE INVENTION

1. Technical Field

The present invention relates to a Web-based method and system utilizing a computer and a compatible electronic mobile device having a bar code reader for retrieving and redeeming store product coupons at a store location.

2. Background Information

With the nation emerging from a damaging recession, grocery store coupons have enjoyed a resurgence of late. As many shoppers are painfully aware, though, using paper coupons can require hours of a shopper's time. The shopper must cut out/collect the coupons, then organize and transport them to the different grocery stores. Coupons beyond their expiration dates must be culled and discarded. Some shoppers use special coupon organizer books or pouches. At the store, the user must stand in front of the subject item and compare the product name, number of ounces or milliliters, etc. to the prospective coupon to determine whether the coupon matches that product. Then the shopper must hold onto and present the proper coupons to the cashier at the register along with the products.

With the coupon retrieval and redemption system and method of the present invention, the shopper is spared from collecting, organizing, culling, and transporting paper coupons. The shopper need not wonder whether he or she was able to locate the latest and best coupons representing the most savings for a particular item.

### BRIEF SUMMARY OF THE INVENTION

The present invention is a Web-based method and system utilizing a computerized mobile device, preferably a mobile phone, for retrieving and redeeming store product coupons at a store. The method comprises the steps of: (1) Offering a Web-based coupon retrieval and redemption application for downloading onto a compatible computerized mobile phone device having a bar code reader; (2) Displaying a system registration questionnaire on a display screen of the compatible mobile device, once the system application has been downloaded to the compatible mobile device; (3) Storing information received from the registration questionnaires in one or more registration databases, the registration questionnaire comprising at least one mobile device compatibility question; (4) If a response to the at least one mobile device compatibility question from the registration questionnaire does not match an item on a pre-determined list, displaying an “incompatible” message on the mobile device display screen and halting the method; and (5) If the response to the at least one mobile device compatibility question of the registration questionnaire does match the item on the pre-determined list, displaying a disclaimer and a disclaimer acceptance option on the mobile device display screen. Any suitable, compatible mobile device with a bar code reader can be used in place of the mobile phone device.

Also included herein is a Web-based system for retrieving coupons and redeeming them at a store, comprising: an application comprising the system webpage, the system application being downloadable onto application-compatible mobile phone devices, each mobile phone having a UPC bar code reader, up-to-the-minute coupon-related purchases associated with an inputted user code are stored in memory being viewable on a previous purchases/history system webpage.

Advantages of the Web-based system and method of the present invention include the following: 1) Enables the consumer to locate the latest and best coupons representing the most savings for a particular item; 2) No special coupon organizers are required, just the mobile phone device the consumer carries anyway; 3) Saves hours of consumers' time heretofore spent collecting, organizing, and culling coupons; 4) Saves the stores the cost of printing and mailing coupons, and advertising coupon specials in newspapers, store flyers, etc.; and 5) Decreases incidents of fraud associated with use of store coupons.

### BRIEF DESCRIPTION OF THE SEVERAL VIEWS OF THE DRAWINGS

A more complete understanding of the invention and its advantages will be apparent from the following detailed description taken in conjunction with the accompanying drawings, wherein examples of the invention are shown, and wherein:

FIG. 1 is a first portion of a flowchart illustrating a system and method according to the present invention;

FIG. 2 shows a second step of a flowchart illustrating a system and method according to the present invention;

FIG. 3 shows a third step of a flowchart illustrating a system and method according to the present invention;

FIG. 4 shows a fourth step of a flowchart illustrating a system and method according to the present invention;

FIG. 5 shows a fifth step of a flowchart illustrating a system and method according to the present invention;

FIG. 6 shows a sixth step of a flowchart illustrating a system and method according to the present invention;

FIGS. 7 and 8 show representative “Cart” screen views generated in accordance with a system and method according to the present invention;

FIGS. 9-11 show Step 4 “Department” and “Item” screen views generated in accordance with a system and method according to the present invention;

FIGS. 12 and 13 show Step 5 screen views generated in accordance with a system and method according to the present invention;

FIG. 14 shows a representative Step 6 screen view generated in accordance with a system and method according to the present invention;

FIG. 15 shows a Step 6 “close-out” screen view generated in accordance with a system and method according to the present invention;

FIG. 16 shows a “Device Incompatibility” screen view generated in accordance with a system and method according to the present invention;

FIG. 17 shows a “Declined Disclaimer” screen view generated in accordance with a system and method according to the present invention;

FIG. 18 shows a “Disclaimer” screen view generated in accordance with a system and method according to the present invention;

FIG. 19 shows a Home Screen generated in accordance with a system and method according to the present invention;

FIG. 20 shows a Information Screen generated in accordance with a system and method according to the present invention;

FIG. 21 shows a Registration Screen generated in accordance with a system and method according to the present invention;

FIG. 22 shows a Registration Screen 1.1 generated in accordance with a system and method according to the present invention;

FIG. 23 shows a Profile Screen generated in accordance with a system and method according to the present invention;

FIG. 24 shows a Profile Screen 1.3: Previous purchases/History generated in accordance with a system and method according to the present invention;

FIGS. 25 and 26 show a Profile Screen 1.4: Merchant/store Locator generated in accordance with a system and method according to the present invention;

FIG. 27 shows a Profile Screen 1.5: Coupon Specials generated in accordance with a system and method according to the present invention; and

FIG. 28 shows a Contact Us Screen generated in accordance with a system and method according to the present invention.

### DETAILED DESCRIPTION OF THE INVENTION

In the following description, like reference characters designate like or corresponding parts throughout the several views. Also, in the following description, it is to be understood that such terms as “front,” “back,” “within,” and the like are words of convenience and are not to be construed as limiting terms. Referring in more detail to the drawings, the invention will now be described.

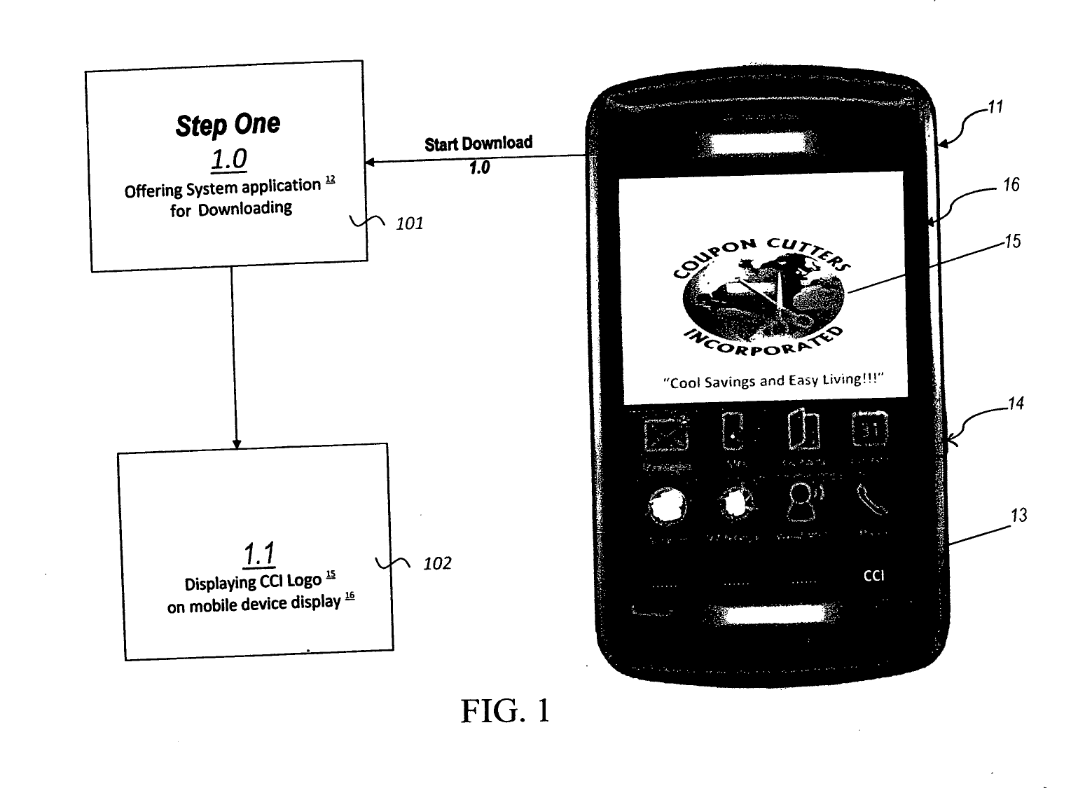

Turning first to FIGS. 1 through 6, operation of a business method and system 10 according to the present invention is illustrated in the form of a six part flowchart. The retrieval and redemption system/method 10 facilitates coupon use by a user in a grocery store or a like business establishment using any coupons the grocery store, or manufacturers of products sold in the grocery store, have made available to consumers/users that day.

The step of receiving the coupon prompt comprises receiving an identifier of the item of interest to the consumer at the store 71. A number of coupons 34 can be selected at the store 71 using the mobile phone device 11 with bar code reader before the coupons 34 are redeemed at the check-out area at the store 71. The consumer has pre-registered his or her mobile phone device 11 with the CCI system 10. The store 71 has also been pre-registered with the CCI system 10, after which the system 10 receives periodic coupon updates from each registered store 71.

Referring to FIG. 1, the present system/method 10 includes the first step of offering a Web-based coupon retrieval and redemption application for downloading onto a user's compatible mobile phone device 11. The mobile phone device 11 must have a bar code reader.

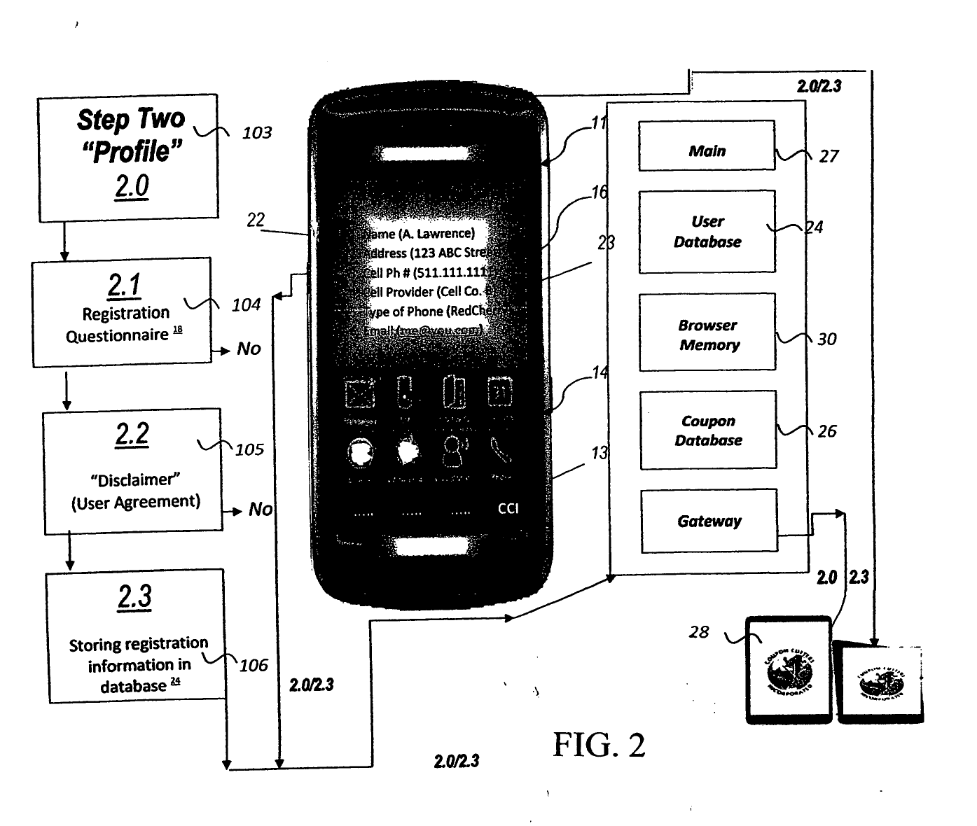

Referring first to FIGS. 1 and 2, use of the system/method 10 of the present invention requires a personal mobile phone device 11, such as a cell phone with a bar code reader. In Step 1 of the present system/method 10, an application of the present invention, called herein Coupon Cutters, Inc., or CCI, application 12, is downloaded onto the customer's mobile phone device 11 from the application store of their mobile phone provider, as seen in Block 101. A CCI logo 15 is preferably displayed on the display screen 16 of the mobile phone device 11, as seen in FIG. 1 and Block 102. The CCI logo 15 is preferably displayed on the display screen 16 with the phrase “Cool Savings and Easy Living!!!” as the first view on the phone display Profile. The CCI application 12 is selected using the CCI App icon 13 on the mobile phone device keypad 14. From Step 1.1, the method 10 moves to Step 2.0, Block 103 “Profile”.

The store herein is preferably a grocery store or the like, but can be any other suitable type of store, such as a general merchandise store, a convenience store, or a department store, that has registered with CCI, so that the system application 12 is available for the store.

By “coupon” herein is meant a voucher redeemed by a store giving a discount on a purchase price of the item of interest to the consumer (e.g., 20% off the purchase price; 2 items for the price of 1 of the same items; buy one item, get one of the same type of item free). A coupon 34 herein can be a virtual coupon, or transferred from the mobile phone device to a flash drive to a personal computer, where the coupon is printed out onto paper or the like.

By “item” herein is meant a purchasable product, such as a can of fruit. An item herein is one in a collection of items in a grocery store or other store, such as an eggplant or a carton of milk.

By “consumer”, or “customer”, is meant a user of the present retrieval and redemption system/method 10, who uses the downloaded Web-based application herein on a registered mobile phone device 11 to shop for and redeem coupons 34 for items of interest to the consumer. He or she is a consumer of the retrieval and redemption system 10 herein, and a CCI customer.

By “registered” herein is meant that information concerning the mobile phone device and its user has been logged in to, and the user has enrolled in, the retrieval and redemption system 10. The Web-based application herein has been downloaded onto the registered mobile phone device.

By “suitable mobile phone device” herein is meant a personal mobile phone device, such as a cellular telephone, a tablet computer, notebook computer, or any Wi/Fi accessible computerized device having a bar code reader, onto which the Web-based application of the present invention can be successfully downloaded.

By “mobile device bar code reader” herein is meant a device or function on the mobile device for scanning and reading bar codes already printed on items for sale in stores.

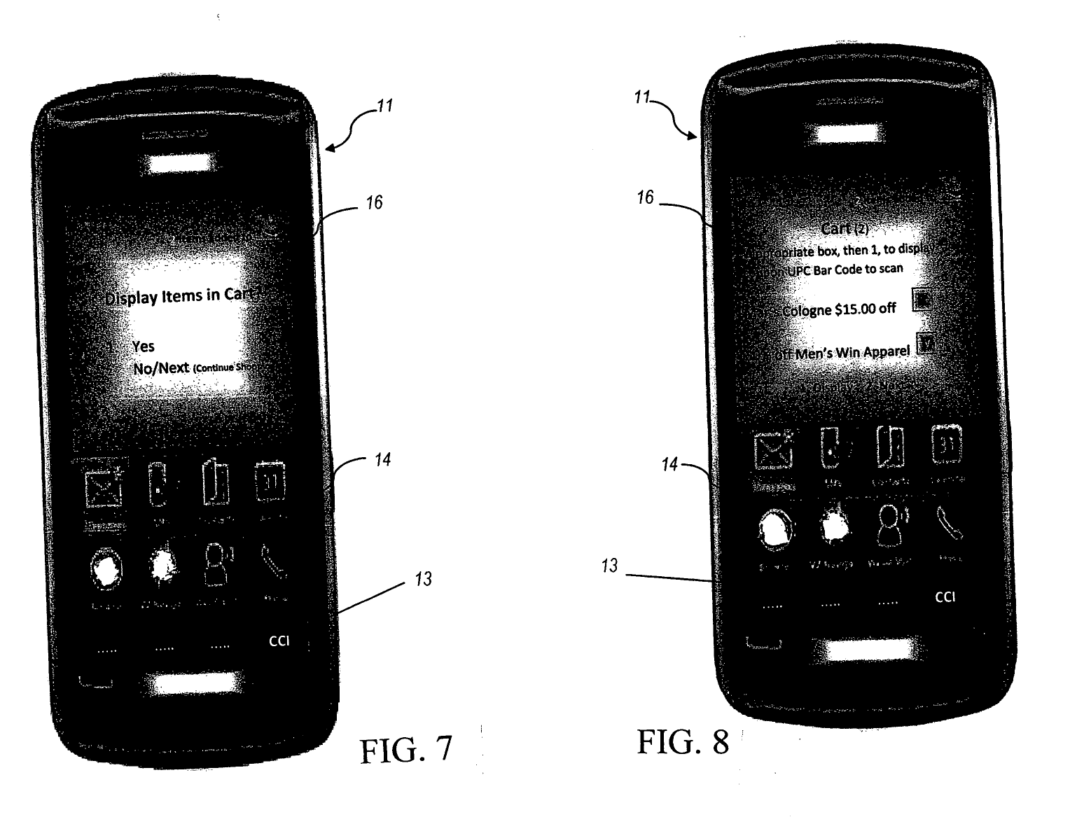

Referring to FIGS. 2, 7, and 8, Step 2.1 comprises displaying a registration questionnaire 18 on the mobile phone display 16 (see Block 104 of FIG. 2). On the registration questionnaire screen 18, the user replies to questions asking for their personal information 22, including the user's name, home address, mobile phone number, and email address. As seen in FIGS. 2 and 7, the user is also asked mobile phone-related compatibility questions 23, such as the cell phone company provider and type of mobile phone device 11, in order to ascertain whether the mobile phone device 11 will be able to run CCI App 12.

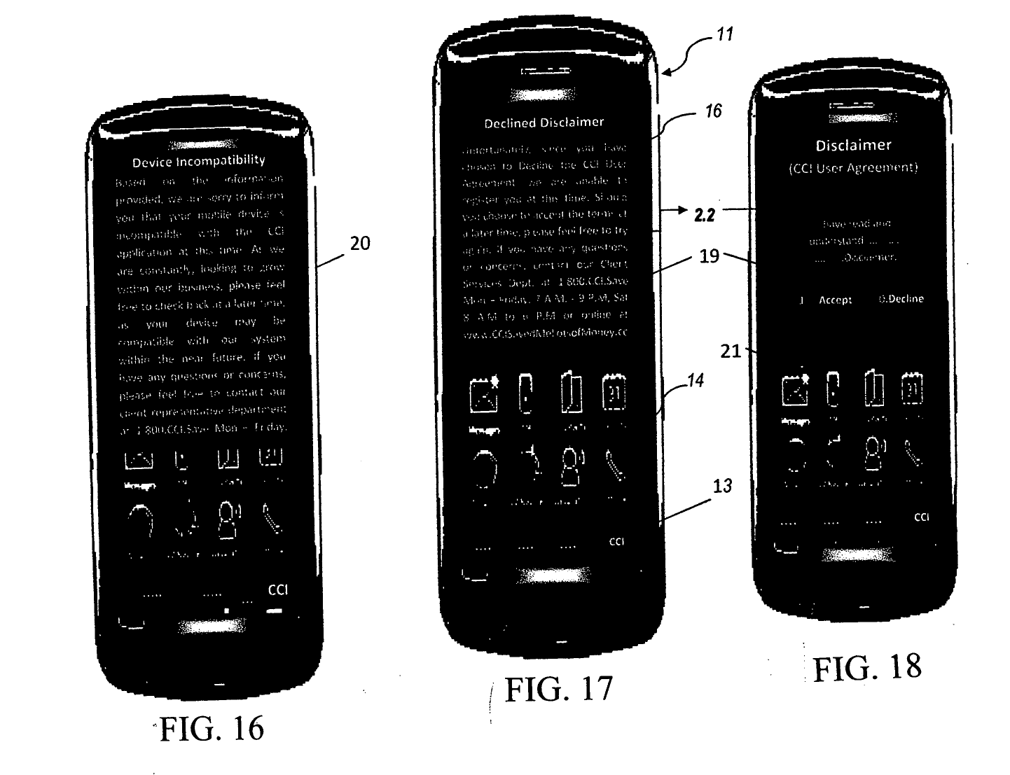

If one or more answers to the mobile phone-related compatibility questions 23 do not fall within a pre-determined CCI-compatible list, the next step of the system 10 comprises displaying a “Phone Device Incompatible”-type screen message 20, such as “Sorry, your system is not compatible with ours,” on the display screen 16, as seen in FIG. 16. Since such users are potential future customers, this screen view 20 preferably also provides a phone number where user questions, if any, can be directed (see FIG. 16). The wording of screen messages according to the present invention need not be as shown; any appropriate language may be used.

If the responses to the cell phone provider, type of phone device, and other mobile phone compatibility questions 23 do match items on the pre-determined list, the next step, 2.2, is displaying a disclaimer on the mobile phone device display 16. As seen in FIG. 18, this disclaimer screen 19 provides a disclaimer for the user to review, and a disclaimer acceptance check box 21 or the like to signify electronically that the customer has read and agrees to the disclaimer and wishes to proceed, as seen in FIG. 2 (see Block 105). If the disclaimer acceptance box 21 has not been checked, this step includes displaying a “Declined Disclaimer” message, as seen in FIG. 17, and halting the process.

Preferred Step 2.3 of the system/method 10 includes storing information received from the registration questionnaires in one or more registration databases 24, as seen in Block 106, preferably on the main computer 27. Individual user's responses to the registration questionnaire 18 are preferably stored in a “Personal Information” database. Inputted answers to the personal information questions on the registration questionnaire are preferably stored in a “CCI Information” database. Cell provider information inputted from multiple users answering the cell phone provider question on the registration questionnaire 18 is channeled to a “Phone Customer Database”. From Step 2.3, the method 10 moves to Step 3.0.

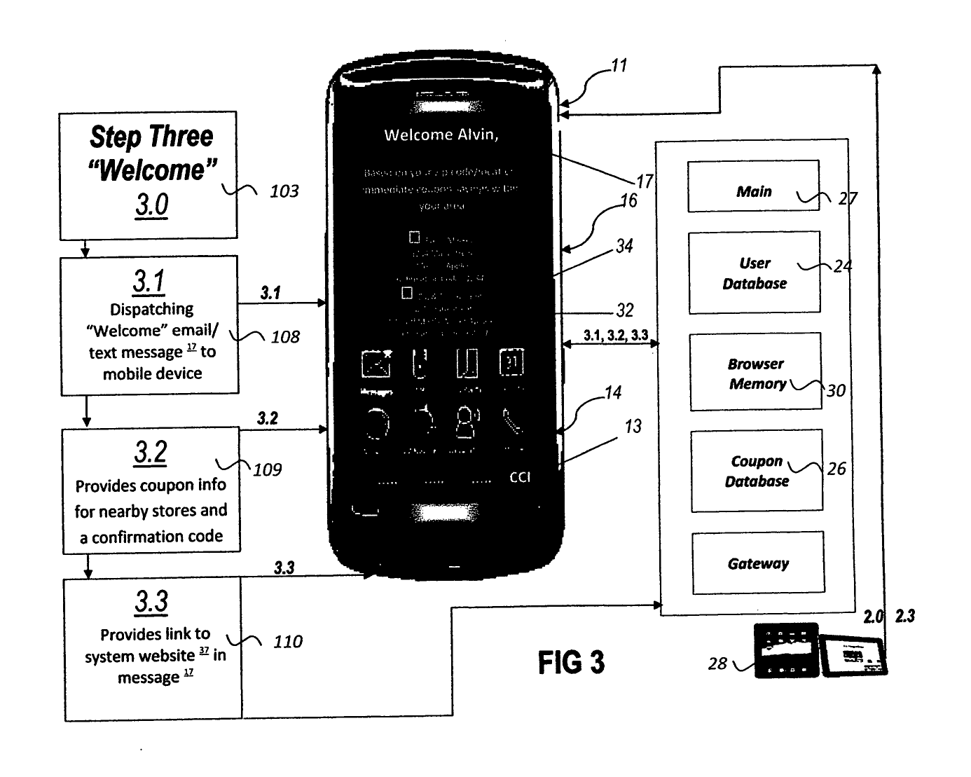

Once the user has registered with CCI App 12, the application is downloaded to the user's mobile phone device 11. In Step 3.0 (see “Welcome” Block 107), once the CCI App 12 is finished downloading to the registered mobile phone device 11, the next step, 3.1, is dispatching a welcome e-mail and/or text message 17 on the display screen 16 of the mobile phone device 11. The welcome text message 17 or e-mail is sent to the phone number or e-mail address that was provided at the time of registration through an automatic responder tool. As seen in Block 108, the message 17 welcomes the customer to CCI. The message 17 greets the customer by the name provided at the time of registration, as seen in FIG. 3.

As seen in Block 109 (Step 3.2), the welcome message 17 also provides information concerning coupons for special and retail locations that are in the geographic area near the mobile phone device using the “CCI App”. This is accomplished using existing geo-location technology. Step 3.2 also includes providing a confirmation code 32 within the body of the message 17 for downloading coupon specials (Block 109).

As seen in Block 110, Step 3.3 includes providing a link to the system website 31 within the body of the e-mail/text message 17 for easy access. Once the customer clicks on the website link, the message provides information on coupons for the special and retail locations in the nearby area that use the “CCI App” (using geo-location technology). From Step 3.3, the method 10 moves to Step 4.0.

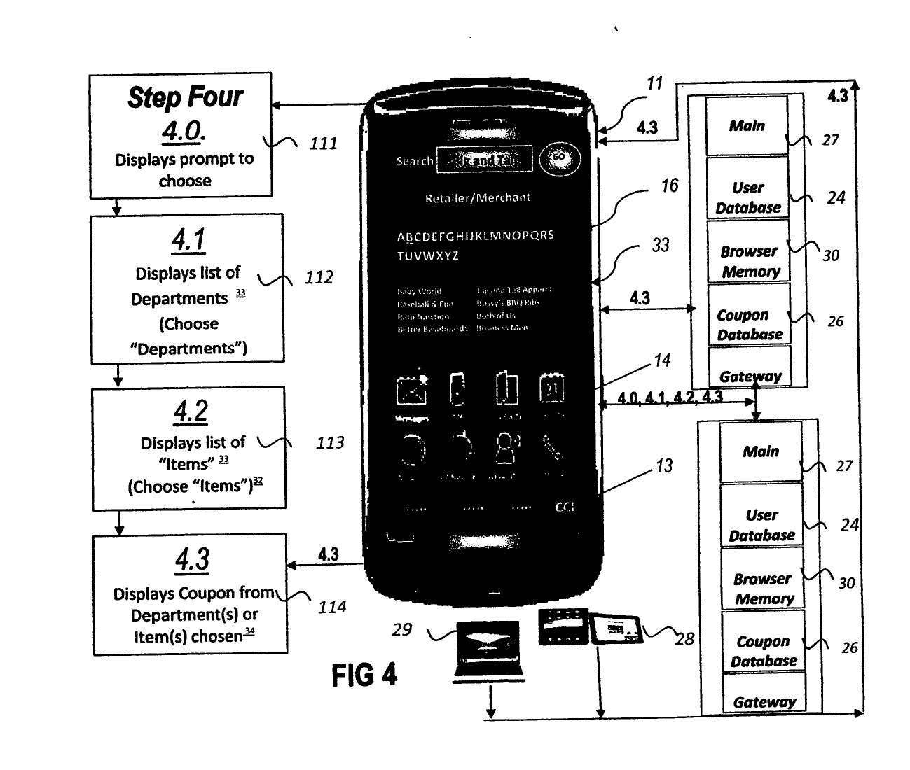

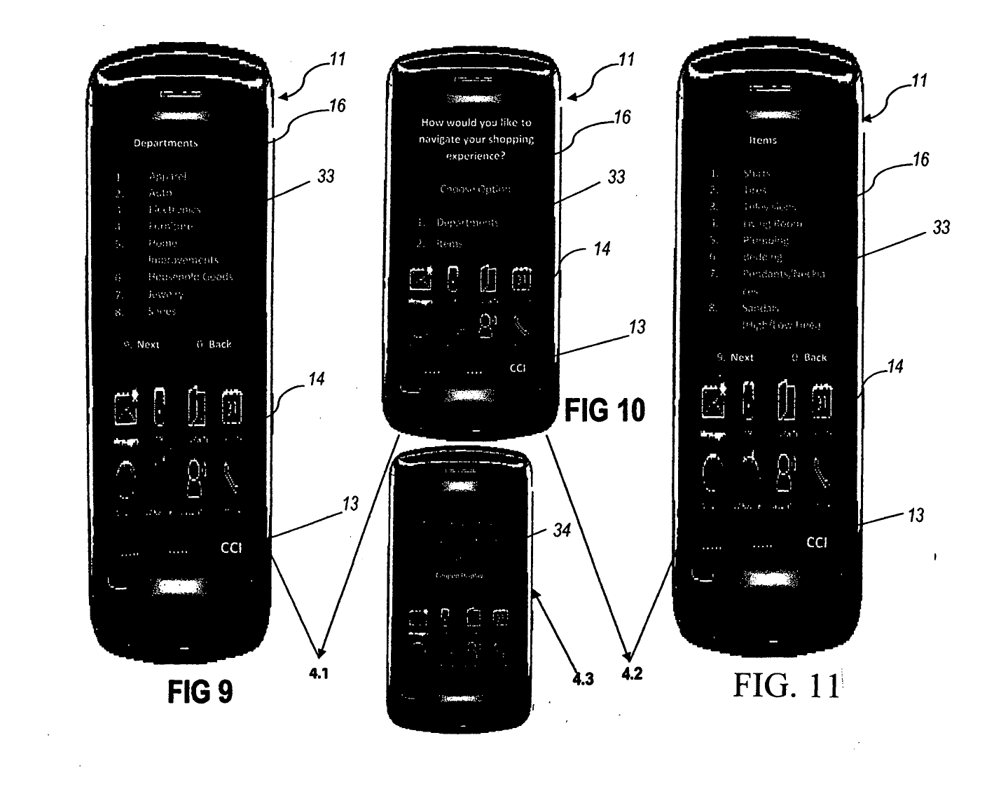

The customer physically goes to a store 71 that is a CCI participant and utilizes the “CCI App” (so the store is “registered”) and initiates the geo-location technology on the mobile phone device 11. In regard to Step 4.0, Block 111 indicates displaying a “Choose store” prompt for choosing a system-registered store/retailer/merchant on the display screen 16 of the mobile phone device 11 (see FIG. 4). Once a registered store 71 is chosen, Step 4.1 (Block 112) of FIG. 4 includes displaying a “Departments/Item” prompt 33 on the display window 16 of the registered mobile phone device 11 with two choice selections: “Departments”, or sections, within the store, or a specific “Item” within the store. As seen in FIG. 10, the message, “How would you like to navigate your shopping experience?” appears on the screen 16. The customer/user chooses between the two, Departments, as seen in FIG. 9, or Items, as seen in FIG. 11.

If “Departments” is selected, Step 4.1 (Block 112) of FIG. 4 comprises displaying a list of the departments of the subject retailer that have coupons 34 on special at that particular time. As seen in FIGS. 9-11, the Items, or products, within that Department that are associated with coupons will display. For each coupon 34, the display shows the amount of savings provided by that coupon 34. For example, the customer may choose “Produce” from the list of Departments, in which case produce-related coupons 34 are displayed on the mobile phone device display window 16. The coupons 34 could be, but are not usually, printed on paper; they are therefore “electronic coupons”. Bar codes are scanned using the mobile phone device bar code reader.

The method is concluded at the check-out counter. Once the user indicates on the mobile phone device 11 that shopping is finished, the mobile phone device 11 goes into configuration mode, generating a store total transaction bar code displayed on the mobile phone device display screen 16. The store total transaction bar code on the user's mobile phone device 11 is scanned at the cash register using the store's bar code scanner/reader 38. This completes the method of the present invention. It is believed that each time the consumer user goes to the participating store 71 to buy groceries, for example, the store transaction code will probably be different, even if it is the same store (s)he went to last time, because the user will likely choose different groceries.

If the “Item” “button” is instead selected, Step 4.2 (Block 113) of FIG. 4 comprises providing a blank with an instruction to type in the particular item for which the customer is searching, as illustrated in FIG. 11. Once the blank is filled and entered, the main computer 27 searches for the filled-in item and displays on the mobile phone device display screen 16 all available coupons 34 for that item. The display shows the amount of savings provided by each coupon. If there is no match, a “Sorry, no such item can be found” message or the like is displayed. This step is followed by scanning the merchant UPC bar code of each item with a bar code reader (a scanner/reader) using the mobile phone device 11 (Step 4.3, Block 114). To scan, the user holds the camera of the mobile phone device 11 up to the bar code on the selected item, and centers the bar code in the screen. Coupons 34 are periodically updated by the store 71.

Once the choice of “Departments” or “Items” has been made, and the products and savings have been displayed on the screen of mobile phone device 11, Step 4.3 (Block 114) comprises updating all of the Departments/Item coupons 34 associated with the CCI App 12 that have been scanned and uploaded by the bar code reader on the mobile phone device 11 into the Coupon Database 26 in the main computer. The computers of registered stores 71 update the CCI main computer daily regarding that day's coupons. From Step 4.3, the method 10 moves to Step 5.0.

As seen in FIGS. 3-6, the mobile phone devices 11 are in communication with a main computer 27 with Internet geo-location technology/coupon server. The main computer 27 has a user/registration database 24, browser memory 30, a coupon database 26, and a Gateway, and/or a tablet computer 28 or laptop 29 or the like.

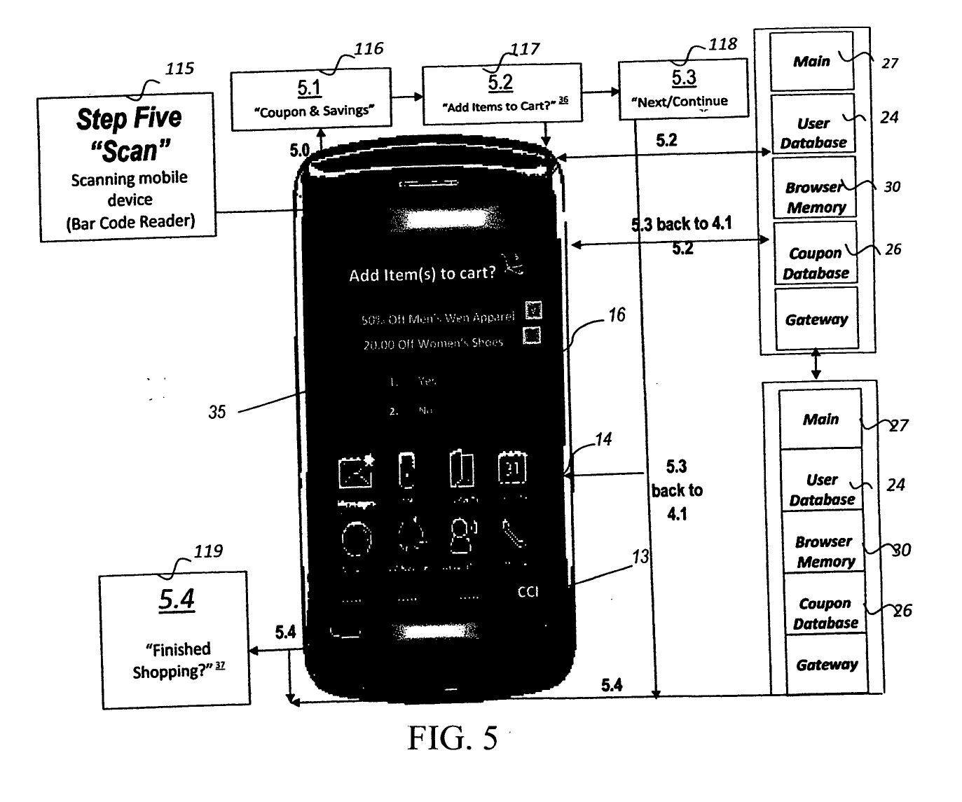

Following completion of the “Department” or “Item” process, the next step, 5.0 (Block 115 of FIG. 5), is scanning the particular items, or products, in the store chosen by the customer. As seen in FIG. 13, the mobile phone device 11 has a bar code scanner/reader 25 for use in scanning the UPC (Universal Product Code) bar codes of the individual items the customer intends to purchase from the store 71. The customer holds the bar code scanner/reader 25 of the mobile phone device 11 over the bar code on the item. Step 5.1, Block 116 is displaying one or more coupons 34 for the selected item in the mobile phone device display window 16 each time an item is scanned. The amount of savings represented by the coupon 34 is preferably displayed along with the coupon 34.

The next step, 5.2, Block 117 of FIG. 5, is displaying an “Add Item to Cart?”-type of message 35 in the mobile phone device display window 16. If yes is chosen and another item is added to the list of items to be purchased, the additional item will be saved to the mobile phone device 11. A “New Price” of automatic savings is then displayed in the mobile phone device display window 16. The price for the additional item will be discounted at the time of scanning.

If on the other hand, the customer chooses not to add an item in response to the “Add Item to Cart?” message 35, Step 5.3, Block 118 presents the option to choose “Next” 36 or “Finished Shopping” 37. As illustrated in FIG. 14, clicking on the “Next” button 36 enables the customer to continue shopping. In that case, the method returns to Step 4.1 until shopping is complete.

As illustrated in FIG. 7, the representative screen 16 displays the message “Display Items in Cart?” and provides options 1) Yes, and 2) No/Next (continue shopping). As seen in FIG. 8, the screen displays the example “Cart” followed by the number of items selected, and the message to check the appropriate box, then 1, to display coupon UPC bar code to scan. The coupon items are then listed, followed by 1) Display, and 2) Next.

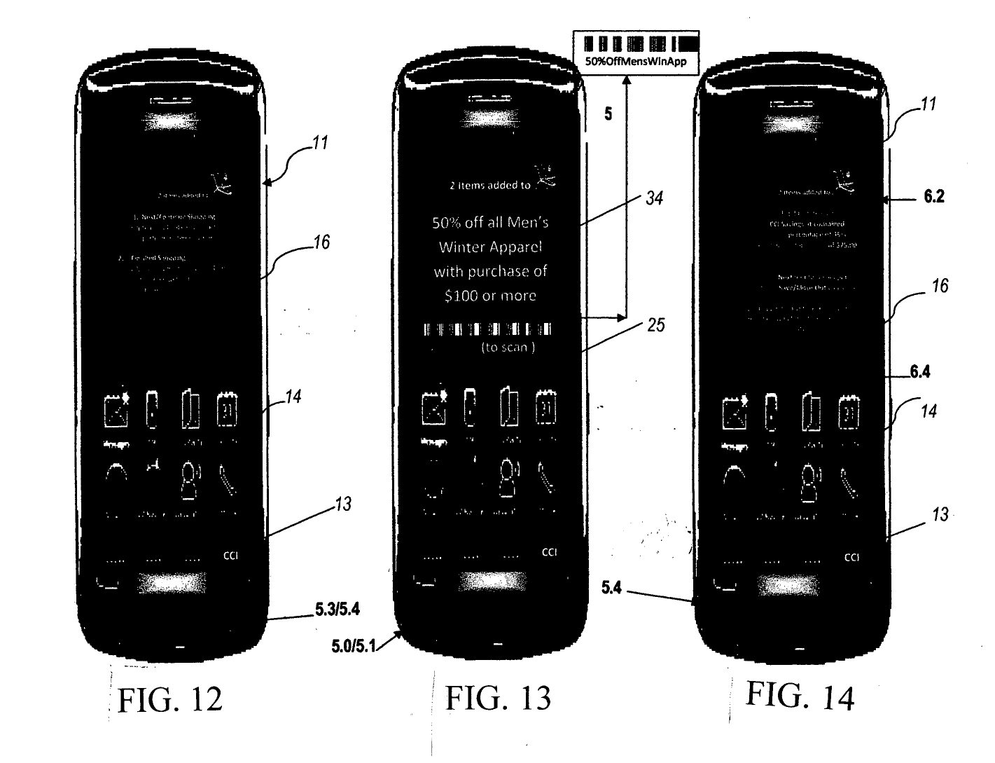

Once the chosen item has been scanned as depicted in FIG. 13 (Step 5.0/5.1), the screen 16 displays the following message: “1) Next/Continue Shopping; and 2) Finished Shopping,” as shown in FIG. 12 (Step 5.3/5.4). Choosing Option 1 takes the user back to the Departments/Items screen. Option 2 takes the user to the “Close Out” screen to finish the purchase. As seen in FIG. 14 (Step 5.4), the screen 16 shows the total number of items and the percentage and dollar amount of savings (Step 6.2). It gives a choice of: “1) Next (Continue Shopping); or 2) Save/Close Out (Log out)”. The message may also state, “For your shopping convenience, coupons may be saved for future use,” as seen in FIG. 14 (Step 6.4).

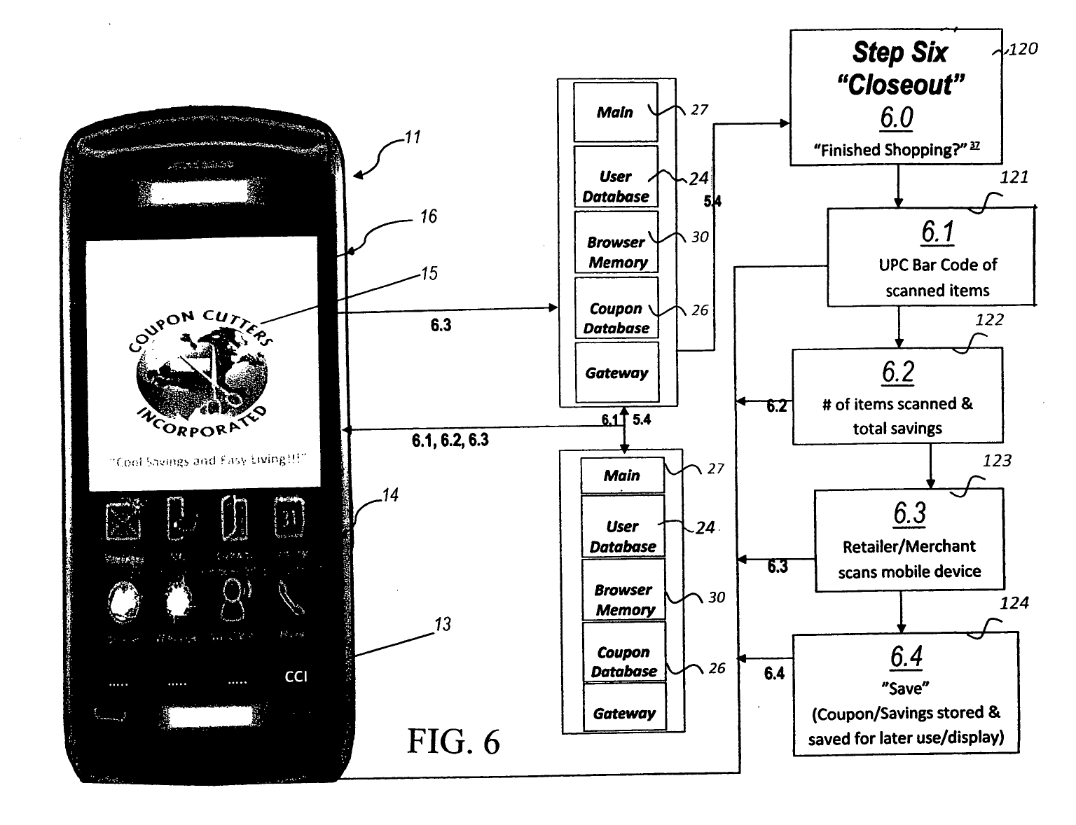

Turning to Step 6.0, Block 120 of FIG. 6, after the customer has chosen all of their products/items and finished their shopping they can select the “Finished Shopping” button 37 and start the close out process. At this time, all of the items that have been scanned are calculated in the system Application 12. This step, 6.1, further includes displaying a UPC Bar Code for each item in the mobile device display window 16 (see Block 121).

Items scanned into the CCI Database are uploaded from the CCI Database once the “Finished Shopping” option has been chosen. This step, 6.2, further includes displaying the number of items scanned, and total dollar amount in savings on the mobile phone device display screen 16 (Block 122).

At the time of check out, the system customer provides the retailer (cashier/store clerk) with the customer's mobile phone device 11 displaying the UPC bar code. In this step, 6.3 (Block 123), the cashier scans a store total transaction code on the mobile phone device 11 using a store bar code scanner/reader 38. The method includes displaying the total amount of savings for the system customer.

In Step 6.4, Block 124 of FIG. 6, comprises automatically saving all scanned Items in the CCI Database for the system customer as a convenience for the customers' next shopping experience using the system Application 12. This closes out the system App 12.

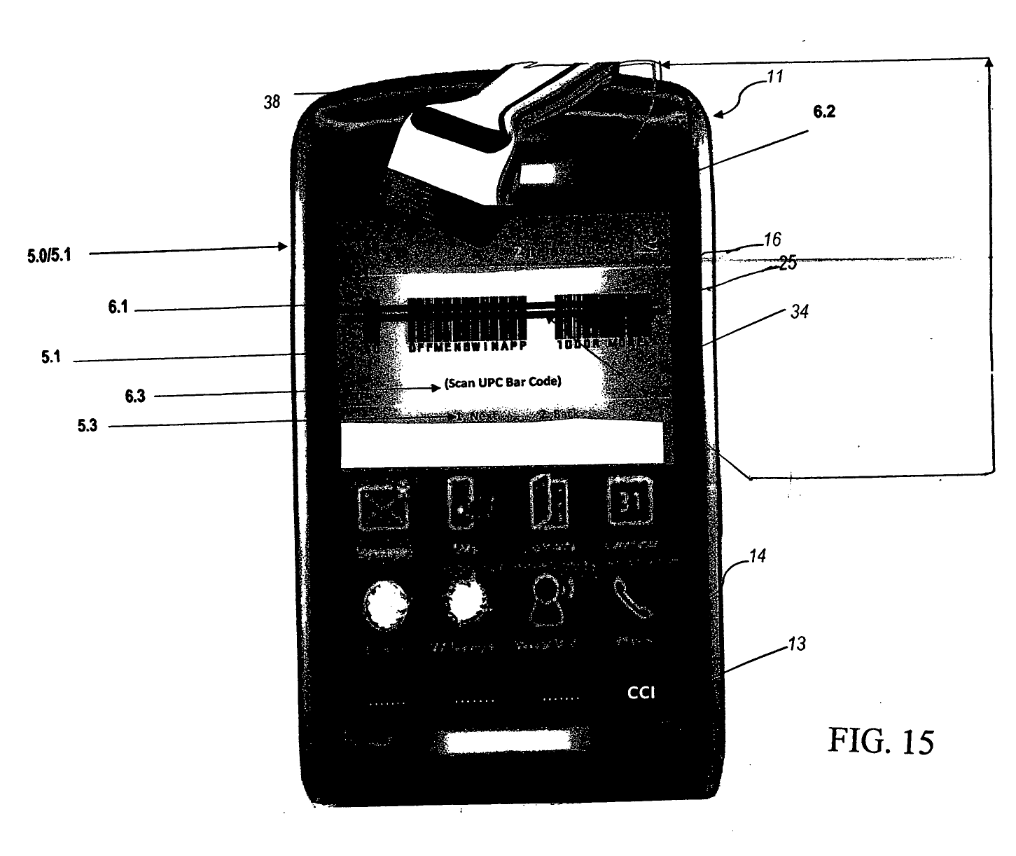

As seen in the close-out screen of FIG. 15, the method includes scanning the total transaction bar code in the mobile phone display window 16 at the store register using the store bar code scanner/reader 38.

While the system App 12 is running, the system customer is still able to receive incoming voice and data calls or messages on the mobile phone device 11. In the event of a call/message, the system App 12 halts or pauses the shopping process and picks up where it left off once the call/message has ended.

The retrieval and redemption method 10, then, comprises the following steps: (1) Offering a system (CCI) application 12 for downloading onto a compatible, portable electronic mobile device 11 with a bar code reader 25, which is preferably a mobile phone device; and optionally displaying a CCI logo 15 on a display screen 16 of the mobile phone device 11; (2) Displaying a system registration questionnaire on the display screen 16 of the mobile phone device 11; (3) Storing information received from the registration questionnaires in one or more registration databases 24, the registration questionnaire comprising questions as to mobile phone device compatibility, such as mobile phone device provider and type of mobile phone device questions; (4) If responses to the mobile phone device provider and type of mobile phone device questions from the registration questionnaire do not both match items on a pre-determined list, displaying a “Phone is incompatible” message on the mobile phone device screen 16 and halting the process; and preferably providing a telephone number for user questions on this “Phone is incompatible” screen view 20; (5) If responses to both the mobile phone device provider and type of mobile phone device questions of the registration questionnaire do match items on the pre-determined list, displaying a disclaimer and a disclaimer acceptance option 21, such as a check box, on the mobile phone device display 16 (see FIG. 18). If the disclaimer acceptance option 21 has not been checked, displaying a “Box not checked”-type message and halting the process.

The retrieval and redemption method 10 further includes the following steps:

(6) Once the system application 12 has finished downloading to the registered mobile phone device 11, dispatching a welcome message 17 on the display screen 16 of the mobile phone device 11. The welcome message 17 preferably further includes: a. The name of the customer as inputted to the registration questionnaire 18; b. Information concerning coupons for stores 71 within a pre-determined radius of the mobile phone device; and c. A confirmation code 32 for downloading coupons 34.

(7) Displaying a “Choose store” prompt for choosing a system-registered store on the display screen 16 of the mobile phone device 11.

(8) Once a particular registered store is chosen using the mobile phone device 11, displaying a “Departments/Item” prompt on the display window 16 of the registered mobile phone device 11 with two choice selections: “Departments” within the store or a specific “Item” within the store.
a. If “Departments” is selected, displaying a list of Departments of the chosen store that have coupons on special at that particular time. Displaying coupons for items within that Department that are associated with coupons. The display shows the amount of savings provided by each coupon.
b. If “Item” is instead selected, providing a blank with an instruction to enter the particular item for which the customer is searching. Once the blank is filled and entered, searching for the sought item and displaying available coupons 34 for the sought item on the mobile phone device display screen 16. The display shows the amount of savings provided by each coupon. If the sought item cannot be found (no match), the step further includes displaying a “Sorry, no such item can be found” message.

The retrieval and redemption method 10 further includes the following steps:

(9) Scanning bar codes of each chosen item in the store 71 using the mobile device bar code reader 25.

(10) Updating the Departments/Item coupons associated with the CCI App 12 that have been scanned and uploaded by the mobile device bar code reader 25 into the Coupon Database 26 in the main computer. The mobile phone devices 11 are in communication with a main computer 27 comprising Internet geo-location technology, a user database, browser memory 30, and a coupon database 26.

(11) Displaying coupons 34 for each item scanned, and displaying the amount of savings represented by each of the coupons 34.

(12) Displaying an “Add Item to Cart?” message 35 in the mobile phone device display window 16. a. If yes is chosen and another item is added to the list of items to be purchased, saving the additional item to the mobile phone device 11, and uploading it into the CCI coupon database 27; Displaying a “New Price” of automatic savings in the mobile phone device display window 16. b. If no is chosen, displaying a “Next” button 36 and a “Finished Shopping” button 37 choice in the mobile phone device display window 16.

(13) Clicking on the “Next” button 36 returns the method 10 to Step 4.1 until shopping is complete.

(14) Clicking on the “Finished Shopping” button 37 initiates the step of automatically saving all scanned Items in the CCI Database for the system customer's later use, then providing a “Thank you for shopping” message in the mobile phone device display window 16. Various wording can be used for the messages herein without departing from the invention.

The system/method 10 does not include a pre-determined credit card, nor are virtual coupons herein loaded onto a processing or other card. Other than a suitable mobile phone device 11, no special machine or equipment is required to use the system/method 10.

CCI stores the registration database 24 on its computer. The system user stores her/his coupon database 26 on her/his own computer for future use, if she/he so desires (see FIG. 14).

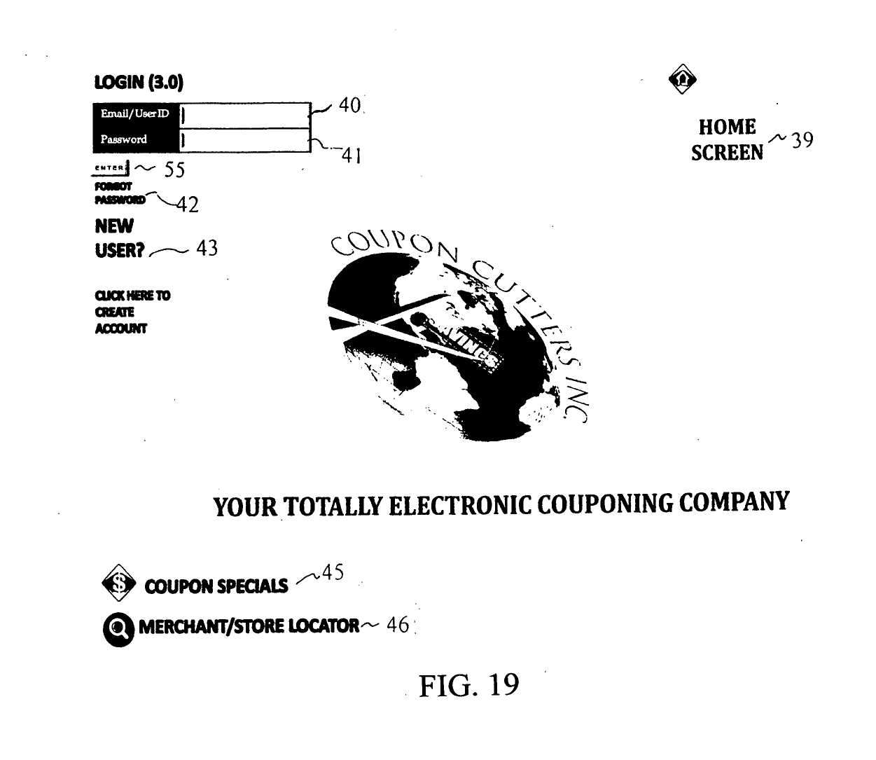

The system and method 10 of the present invention can also be employed using a laptop 29. FIGS. 19-30 show representative screens according to a system website 31, which would appear on the laptop display screen once the user brings up the website 31.

First, FIG. 19 shows a representative Home Screen 39 of the system website 31, which offers an “email/user ID” blank 40 for filling in the email address or user ID, and a blank 41 for filling in the user's password where one has been assigned, as well as a “Forgot password?” message to click on if the user needs a password reminder. A new user would alternatively click on “New User? Click here to create account”, which would transfer to the registration screen 44. The Home Screen 39 also offers a “Coupon Specials” button 45 (site) and a “Merchant/store Locator” button 46 to transfer to the appropriate screen for the user's convenience.

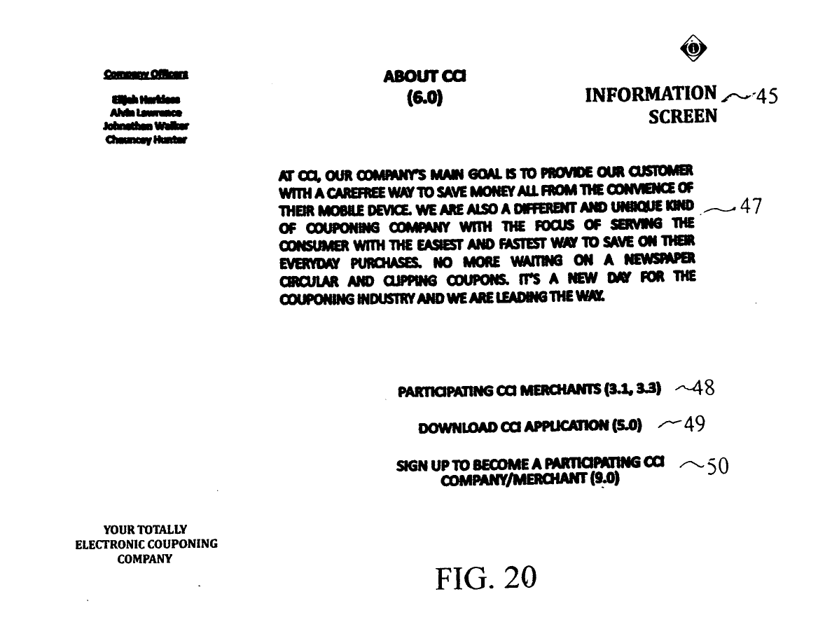

Second, FIG. 20 shows an Information Screen 45 entitled “About CCI”, which provides a description 47 of the company goal. Three items can be clicked on this page: a) “Participating CCI Merchants” 48, which presents a list of merchants who participate in CCI; b) “Download CCI Application” 49 for downloading the CCI App 12 to the user's mobile device; and c) “Sign up to Become a Participating CCI Company/merchant”50, which transfers to a screen allowing a merchant/retailer or business to sign up with CCI App 12 for use at their place of business. A notice is presented if “Download CCI Application” 49 is clicked but the particular mobile device type inputted is incompatible with the CCI App 12.

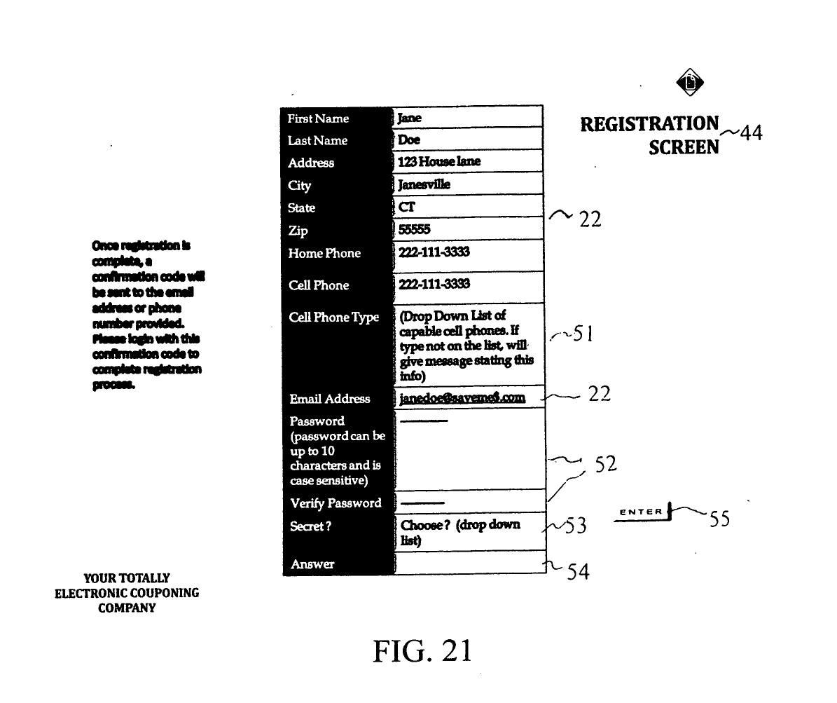

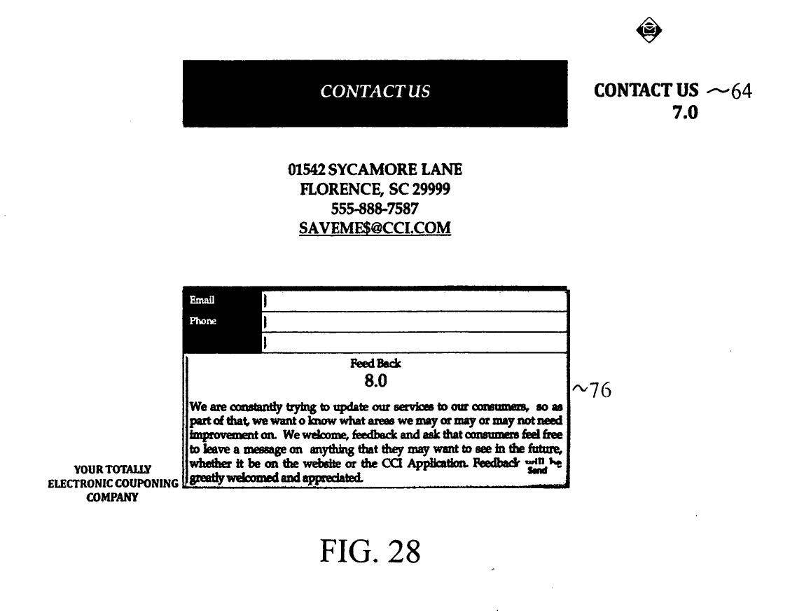

The Registration Screen 44 shown in FIG. 21 includes blanks for entering personal information 22, including the user's mailing address, email address, and phone number(s). A drop down list 51 of capable cell phones is provided. A message is preferably displayed on this registration page stating that CCI would be pleased to respond to email inquiries regarding cell phone types that are not on the drop down list, and that inquiries can be made using the “Contact Us” 64 page (see FIG. 28). The Registration Screen 44 also includes password blanks 52 for the user to choose a password and verify the password. It includes a drop down list 53 for choosing a secret question, an Answer blank 54 for providing an answer to the secret question, and an Enter button 55.

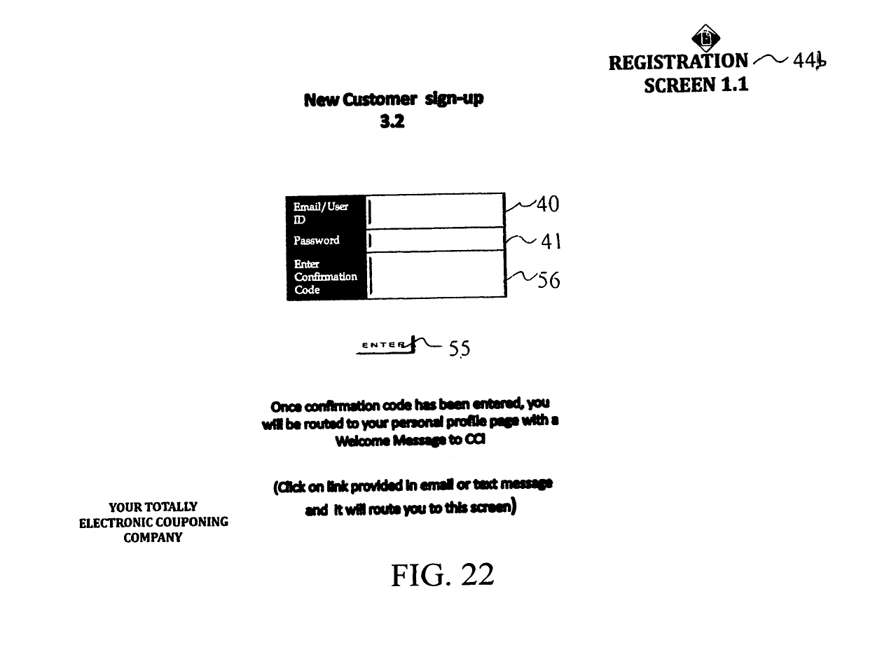

Once registration is complete, and the Enter button 55 has been clicked, a confirmation code 32 unique to the user is produced and sent to the email address or phone number that has been provided. As seen in FIG. 22 “New Customer Sign-up”, Registration Screen 1.1 44b includes three blanks. The first two are a email/user ID blank 40 for entering the email address or user ID, and a password blank 41 is for filling in the user's chosen password. The third blank 56 is for entering the system-generated Confirmation Code 32. An on-screen “Enter” button 55 is then clicked. Login with the Confirmation Code 32 completes the registration process. An email, or text message, containing a link is then automatically sent to the email address, or phone number, respectively, the user entered at registration. The message instructs the user to click on a link provided in the email, or text message.

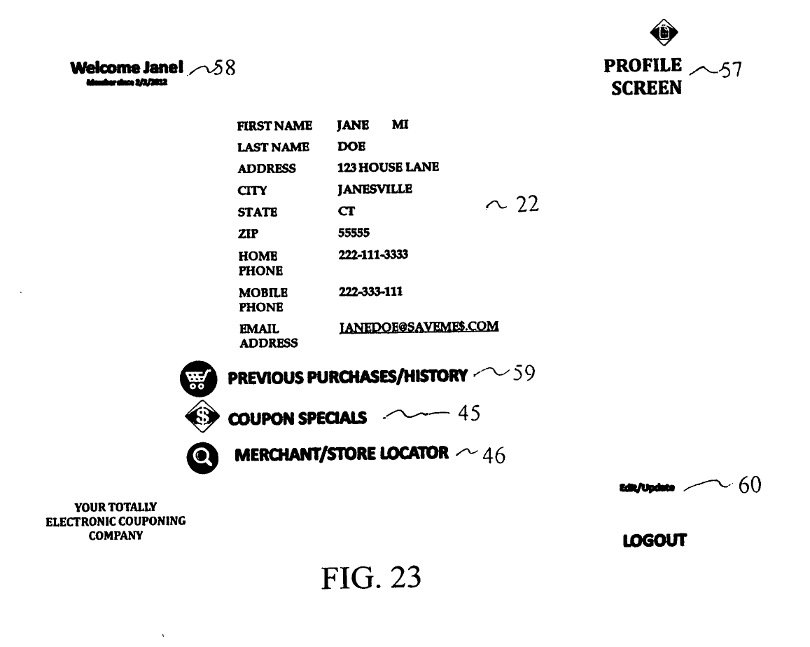

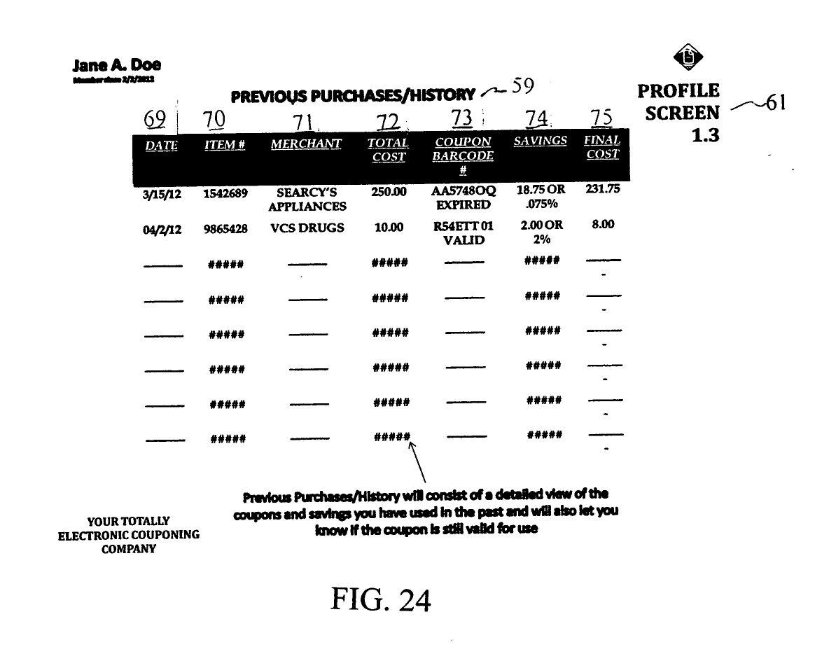

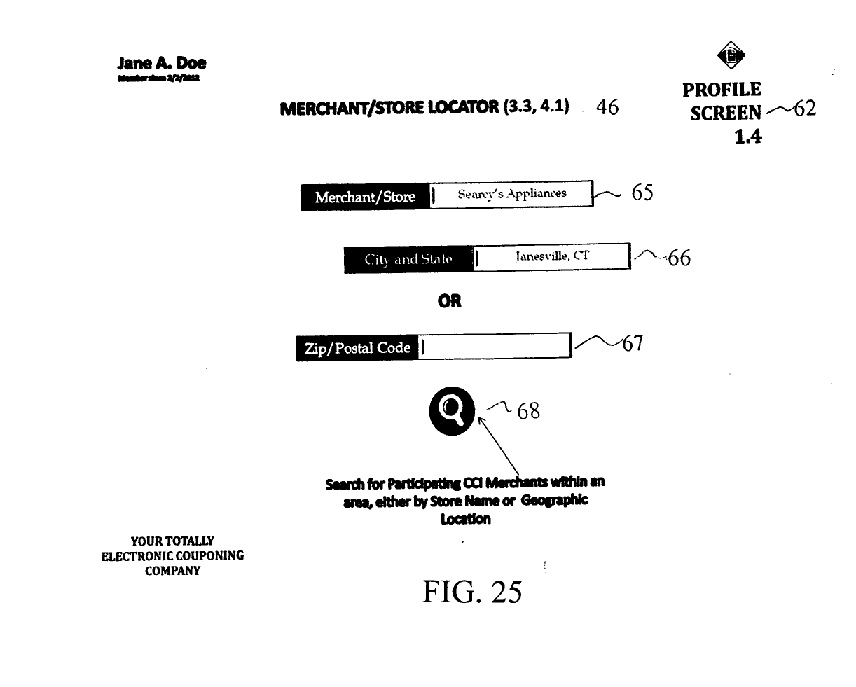

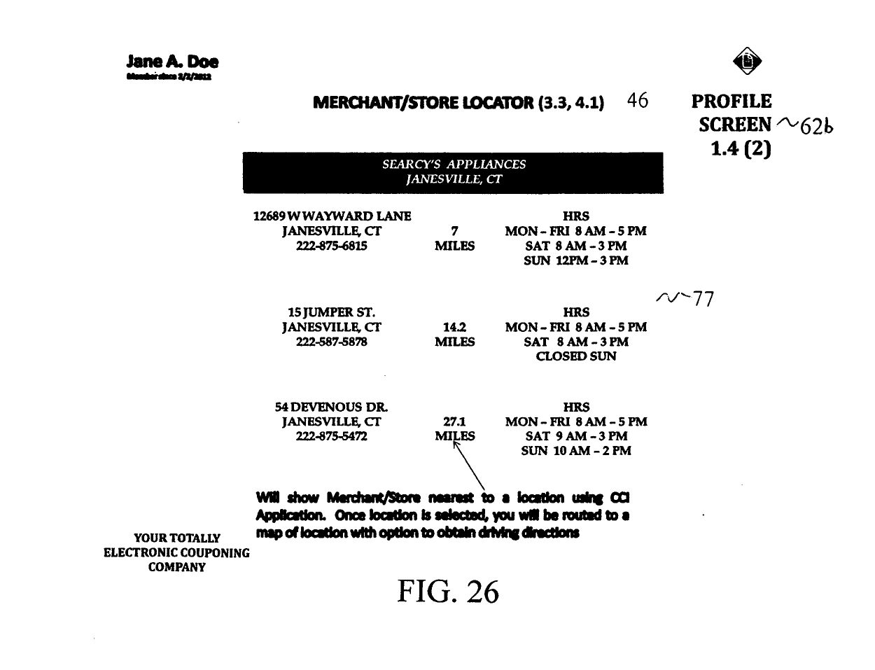

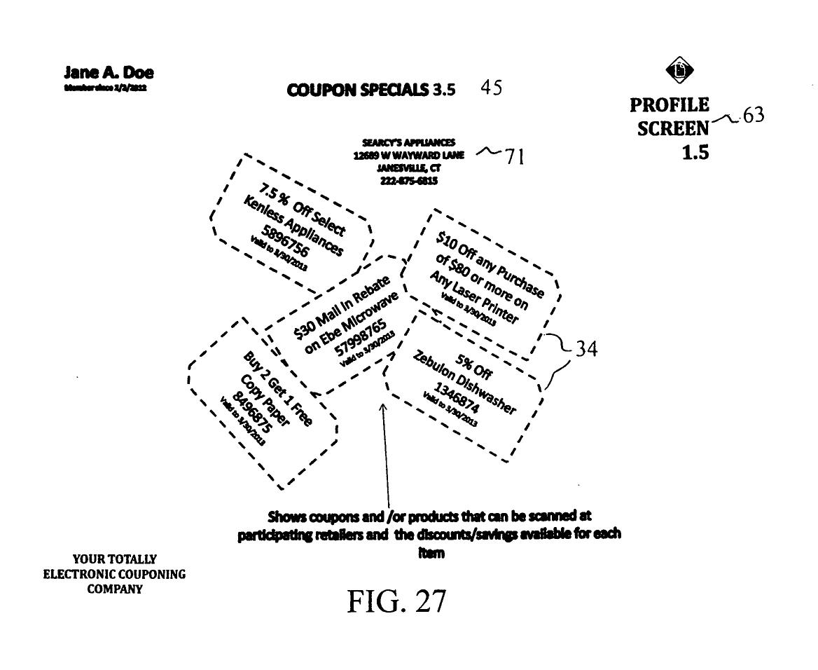

Once the link has been clicked on, the CCI system 10 automatically presents a personal profile page for the particular user. As seen in FIG. 23, the Profile Screen 57 includes a “Welcome, Name!” message 58, which preferably includes the phrase “Member since [date]”. The Profile Screen 57 presents the user's name and other personal information 22 entered at registration. The Profile Screen 57 includes three choices: a) “Previous Purchases/History” 59 (see FIG. 24), b) “Merchant/store Locator 46 (see FIGS. 25 and 26), and c) “Coupon Specials” 45 (see FIG. 27).

The electronic couponing system 10 preferably includes capability for the consumer to modify his or her personal information 22 (entitled “Existing Customer Info”). This is accessed by clicking on the “Edit/update button 60 on the Profile Screen 57, as seen in FIG. 23. The user can Logout, if desired.

Regarding the first choice on the Profile Screen 57, clicking on “Previous Purchases/History” 59 opens a webpage listing previously used coupons 34 and products for that user, and indicates whether those coupons 34 are still valid for use for current or future purchases, as seen in FIG. 24. The table in FIG. 24 shows the date of purchase 69, the item number 70, the merchant/store 71, the total cost 72, the coupon barcode number 73, the amount of savings 74, and the final cost 75. “Previous purchases/history” provides a detailed view of the coupons 34 the consumer has used in the past and the savings, and states whether the coupon 34 is still valid for use. In FIG. 24, see “Valid” and “Expired” notations in Coupon barcode number 73 column. User profiles and each user's up-to-the-minute coupon-related purchases, which are associated with the user's inputted code (Confirmation Code), are stored in memory, and are viewable on the previous purchases/history 59 system webpage. This allows for a streamlined system that is individualized for each CCI customer, from brand new CCI customers to those who have been customers for years.

In regard to the “Merchant/store Locator” 46 choice on the Profile Screen 57 (FIG. 23), the CCI system 10 includes the “Merchant/store Locator” page, which shows merchants/stores within a geographic area that participate in CCI. As seen in FIG. 25, the website page provides blanks for entering the merchant/store name 65, and the merchant/store's city and state 66, or the zip code 67. The CCI system 10 also allows searches of its CCI participating merchant/store database. To conduct a search for participating CCI merchants/stores 71 by name or within a particular geographic area, the user clicks on the search button 68 on the “Merchant/store Locator” page, as seen in FIG. 25.

The CCI system 10 also offers a service for participating merchants/stores 71, and for users: when a user clicks on a particular merchant/store name on the webpage, a screen will display store information 77 for that merchant/store 71, as shown in FIG. 26. Store information 77 preferably includes store locations and hours for the participating merchant/store 71, and the distance of the store location(s) from an inputted location. The user can use the system website 31 to find a store location close to their house, for example. The electronic couponing system 10 includes the capability of navigating to a map of the store location once a store location has been selected. The capability preferably includes a driving directions option showing the user how to get to the selected store location.

Regarding the “Coupon Specials” choice on the Profile Screen 57 (FIG. 23), the CCI system 10 includes a “Coupon Specials” 45 system webpage (FIG. 27). This page displays coupons 34 for particular consumer products, or items, as seen in FIG. 27. The amount of savings (e.g., % off, “buy 2 get 1 free”, mail in rebate) for each product/item if the coupon 34 is used is also indicated (see FIG. 27).

Lastly, FIG. 28 shows the Contact Us Screen 64, which allows the user to email CCI. The Contact Us Screen 64 preferably includes a feedback message 76 requesting feedback from consumers.

From the foregoing it can be realized that the described method of the present invention may be easily and conveniently utilized as a Web-based method and system utilizing a mobile device for retrieving and redeeming store product coupons at a store. It is to be understood that any dimensions given herein are illustrative, and are not meant to be limiting.

While preferred embodiments of the invention have been described using specific terms, this description is for illustrative purposes only. It will be apparent to those of ordinary skill in the art that various modifications, substitutions, omissions, and changes may be made without departing from the spirit or scope of the invention, and that such are intended to be within the scope of the present invention as defined by the following claims. It is intended that the doctrine of equivalents be relied upon to determine the fair scope of these claims in connection with any other person's product which fall outside the literal wording of these claims, but which in reality do not materially depart from this invention. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

### BRIEF LIST OF REFERENCE NUMBERS USED IN THE DRAWINGS

10 CCI system/method
11 mobile phone device
12 Application
13 App icon
14 mobile phone device keypad
15 CCI logo
16 display screen
17 welcome message
18 “registration questionnaire” screen
19 “disclaimer” screen
20 “device incompatible” screen
21 disclaimer acceptance option
22 personal information
23 mobile phone compatibility questions
24 registration database
25 mobile device bar code reader
26 coupon database
27 main computer
28 tablet computer
29 laptop
30 browser memory
31 system website
32 confirmation code
33 Departments/Item prompt
34 coupon
35 “Add Item to Cart?” message
36 “Next” button
37 “Finished Shopping” button
38 store bar code scanner/reader
39 Home Screen
40 “email/user ID” blank
41 password blank
42 “Forgot password?”
43 “New User?”
44 Registration Screen
45 “Coupon Specials”
46 “Merchant/store Locator”
47 “About CCI” description
48 “Participating CCI Merchants”
49 “Download CCI Application”
50 Sign up to Become CCI Merchant
51 Drop down menu for cell phone types
52 password blanks
53 drop down secret question list
54 secret answer blank
55 Enter button
56 confirmation code blank
57 Profile Screen
58 welcome message
59 “Previous Purchases/history”
60 Edit/update button
61 Profile Screen 1.3
62 Profile Screen 1.4
63 Profile Screen 1.5
64 Contact Us Screen
65 merchant/store name blank
66 merchant city and state
67 merchant zip code
68 search for CCI merchants
69 date of purchase
70 item number
71 store
72 total cost
73 coupon barcode number
74 savings amount
75 final cost
76 feedback message
77 store information

What is claimed is:

1. A Web-based method for retrieving and redeeming product coupons at a store, the method comprising a first sequence of steps as follows: (1) Offering a system application for downloading onto a compatible computerized electronic mobile device comprising a bar code reader; (2) Displaying a system registration questionnaire on a display screen of the compatible mobile device, once the system application has been downloaded to the compatible mobile device; and (3) Storing information received from the registration questionnaires in one or more registration databases, the registration questionnaire comprising at least one mobile device compatibility question.

2. The method according to claim 1, further comprising: (4) If a response to the at least one mobile device compatibility question from the registration questionnaire does not match an item on a pre-determined list, displaying an “incompatible” message on the mobile device display screen and halting the method; and (5) If the response to the at least one mobile device compatibility question of the registration questionnaire does match the item on the pre-determined list, displaying a disclaimer and a disclaimer acceptance option on the mobile device display screen; wherein the mobile device is a Wi/Fi accessible mobile phone device.

3. The method according to claim 2, wherein the “phone incompatible” message step further comprises providing a system phone number for questions on the “Phone is incompatible” screen view.

4. The method according to claim 2, wherein the step of displaying the disclaimer further comprises, if the disclaimer acceptance box has not been checked, displaying a “Box not checked” message and halting the method.

5. The method according to claim 2, further comprising a second sequence of steps as follows: (6) Dispatching a welcome message to the display screen of the mobile phone device; and (7) Displaying a “Choose store” prompt for choosing a system-registered store on the display screen of the mobile phone device.

6. The method according to claim 5, wherein the registration questionnaire comprises mobile phone device provider and type of mobile phone device questions; and wherein the welcome message further comprises: (a) the name of the customer inputted to the registration questionnaire; and (b) information concerning coupons for stores within a pre-determined radius of the mobile phone device.

7. The method according to claim 5, further comprising: producing and sending a user-specific system confirmation code to an address of the user.

8. The method according to claim 5, further comprising a step of: (8) Displaying a “Departments/Item” prompt on the display window 16 of the registered mobile phone device with two choice selections: “Departments” within the store or a specific “Item” within the store.

9. The method according to claim 8, wherein, if “Departments” is selected, displaying a list of Departments of the chosen store with coupons available at that time; and, if a Department is selected, displaying a plurality of coupons for items within that Department that are associated with coupons, the display showing the amount of savings provided by each of the coupons.

10. The method according to claim 8, wherein, if “Item” is selected, providing a blank with an instruction to type in a name of the item sought, and, once the blank is filled and entered, searching for the sought item and displaying available coupons for the sought item on the mobile phone device display screen.

11. The method according to claim 8, wherein, if “Item” is selected, providing a blank with an instruction to type in a name of the item sought, and, if the sought item cannot be found, displaying a “Sorry, no such item can be found” message.

12. The method according to claim 8, further comprising the steps of: (9) scanning item bar code using the mobile device bar code reader; and (10) Updating the coupons that have been scanned, coupon information being uploaded by the mobile device bar code reader into a Coupon Database.

13. The method according to claim 12, further comprising the step of: (12) Displaying an “Add Item to Cart?” message in the mobile phone device display window, and, if yes is chosen and another item is added to the list of items to be purchased, saving the additional item to the mobile phone device, uploading it into the system database, and displaying a “New Price” of automatic savings in the mobile phone device display window.

14. A Web-based method for retrieving and redeeming product coupons at a store, the method comprising the steps of: a) Offering a Web-based coupon retrieval and redemption application for downloading onto a compatible registered mobile phone device; b) Once the Web-based application has been downloaded onto the registered mobile phone device and activated, receiving a coupon prompt from the registered mobile phone device for at least one item of interest at the store; c) Searching a system database of the Web-based application for at least one coupon corresponding to the at least one item of interest; d) Retrieving and forwarding the at least one coupon to the registered mobile phone device in response to the coupon prompt at the store; e) Displaying the at least one coupon in a display window of the registered mobile phone device for selection; and f) Upon selection of the at least one coupon, initiating a system for redeeming the at least one coupon at the store.

15. The method according to claim 15, wherein the step of receiving the coupon prompt comprises receiving an identifier of the item of interest at the store.

16. A Web-based system for retrieving and redeeming coupons, the system comprising: an application comprising at least one system webpage, the system application being downloadable onto a plurality of application-compatible electronic mobile devices, each mobile device comprising a bar code reader; wherein a plurality of up-to-the-minute coupon-related purchases associated with an inputted system user code are stored in memory, and are viewable on a previous purchases system webpage of a website of the Web-based system.

17. The Web-based system according to claim 16, further comprising a searchable database of participating merchants/stores, a system webpage of the system website displaying an option for a search for participating CCI merchants/stores by name or within a geographic area.

18. The Web-based system according to claim 16, further comprising displaying store information of each participating merchant/store of the system on a “Merchant/store Locator” system webpage.

19. The Web-based system according to claim 16, wherein the previous purchases system webpage displays a date each coupon-related purchase was made, a store where the coupon-related purchase was purchased, a coupon barcode number of a coupon associated with the coupon-related purchase, an amount of savings from the coupon, and the cost of the coupon-related purchase.

20. The Web-based system according to claim 16, wherein the system website further comprises a coupon specials system webpage, which displays a plurality of coupons for a plurality of consumer products, along with an amount of savings for each coupon if the coupon is used.
